(19) United States
(12) Patent Application Publication
(10) Pub. No.: US 2012/0216469 A1
(43) Pub. Date: Aug. 30, 2012

(54) In-Wall Pipe and Conduit Location Indicator Apparatus and Methods of Using the Same

(76) Inventor: Joshua Mescall, (US)

(21) Appl. No.: 13/354,208

(22) Filed: Jan. 19, 2012

Related U.S. Application Data
(60) Provisional application No. 61/447,574, filed on Feb. 28, 2011.

(51) Int. Cl. E04C 2/52; G01D 21/00; E04B 1/35; G09F 3/00

(52) U.S. Cl. 52/220.1; 40/299.01; 116/209; 52/741.1

(57) ABSTRACT

An apparatus aids in indicating the location of pipe and conduit that may be within or behind walls. Specifically, an in-wall pipe and conduit location indicator apparatus helps to indicate the presence and location of pipes and conduit disposed behind drywall wallboard within a room in a building. Methods of using the same are further provided.

### TECHNICAL FIELD

The present invention relates to an apparatus for indicating the location of pipe and conduit that may be within walls. Specifically, the present invention relates to an in-wall pipe and conduit location indicator apparatus for indicating the presence and location of pipes and conduit disposed behind drywall wallboard within a room in a building. Methods of using the same are further provided.

### BACKGROUND

A building, such as a house, typically has a plurality of rooms that are typically built by framing the rooms and walls thereof using wood or other material as studs that are typically and generally evenly spaced around the room to form the walls. The studs are, generally, 12 inches to 16 inches apart from each other, and typically run vertically from a baseboard to a header. Once the rough walls, ceiling and floor are constructed within a room, electricians and plumbers typically add the pipes and conduit in specific locations between studs such that the pipes and conduit run behind the walls once fully constructed. This allows electricity, water and other materials, such as waste from toilets and the like, to flow through the walls without exposure to those living and/or residing in the open space of the room.

After the pipes and conduit are laid between studs in the wall, the walls are generally constructed by the placement of drywall wallboard over the studs to form the walls. Drywall, generally in 4 foot by 8 foot sheets, is placed against the studs and typically nailed, screwed, adhered, or otherwise permanently affixed to the studs. After affixing the drywall, the seams between drywalls sheets are typically taped and the nail or screw holes are typically filled with spackle and sanded to provide a smooth wall surface.

Finally, a finisher may place trim and other like material on the walls, such as on the baseboards of the walls, along the headers of the walls and around door and window frames. However, it is typically difficult for a finisher to determine the location of any pipes, conduits and/or other material that may be disposed behind the walls. A finisher typically nails and/or screws trim to the walls to affix the trim to the walls. Generally, the trim is affixed to the studs, baseboard, header board, or into the door and/or window frames. However, in some cases, the nails and/or screws used to affix the trim may miss the wood. In these situations, it is preferable that the nails merely hit the vacant space behind the walls. However, in some cases, errant nails and/or screws may hit pipes, conduit and/or other material placed behind the walls, puncturing the same and causing damage to the pipes, conduit and/or other material disposed therebehind.

Moreover, damage to pipes, conduit and other materials disposed behind walls may cause catastrophic damage to a building. For example, if an errant nail and/or screw punctures a water pipe behind a wall, the pipe may burst causing a cascade of water to flow therefrom, causing damage to the building. In some cases, the leakage of water from pipes may not be noticed right away and water damage to the building may not occur until well after people have left the building. Moreover, an errant nail and/or screw may simply weaken a pipe, causing the pipe to burst at another time, which may remain undetected for a period of time.

In addition, an individual that punctures a conduit containing an electrical feed may be subject to injuries and even death from electricity that may flow from the conduit. Specifically, a nail and/or screw that may puncture conduit may contact live electrical wires that may be contained therein, which may cause electricity to flow therefrom and into the body of an individual.

Typically, the location of pipes, conduits and/or other materials behind walls is tracked or otherwise communicated in some fashion to others who may be at risk of puncturing pipes and/or conduits contained behind walls. Maps may be drawn up, or markings may be placed on walls or on the floor in these locations indicating that there are pipes behind the walls and care should be taken when fixing trim or other materials to the wall in these locations. However, in many cases, maps may be misplaced, or individuals may not follow the maps drawn up. Moreover, markings placed on the walls may be painted over or otherwise removed prior to placing trim or other materials on the walls. In addition, markings placed on the floor in the general vicinity may be covered with floor coverings, underlayments, carpeting or other materials during the construction of the room.

A need, therefore, exists for apparatuses, systems and methods of using the same for providing an indication relating to the location of pipes, conduits and/or other materials that may be contained behind walls. Specifically, a need exists for apparatuses, systems and methods of using the same for providing information concerning the specific location of pipes, conduits and/or other materials behind walls during the construction of a building.

Moreover, a need exists for apparatuses, systems and methods of using the same for providing an immovable indicator for providing the location of pipes, conduits and/or other materials behind walls. A need further exists for apparatuses, systems and methods of using the same allowing an individual to obtain precise location information concerning pipes, conduits and/or other materials contained behind the walls within a room.

Further, a need exists for apparatuses, systems and methods of using the same requiring an individual to provide an acknowledgment of receiving the information concerning the location of the pipes, conduits and/or other material located behind a wall during construction thereof. Still further, a need exists for apparatuses, systems and methods of using the same that allow viewing of the pipes, conduits and/or other materials behind a wall, even after construction of the wall.

### SUMMARY OF THE INVENTION

The present invention relates to an apparatus for indicating the location of pipe and conduit that may be within or behind walls. Specifically, the present invention relates to an in-wall pipe and conduit location indicator apparatus for indicating the presence and location of pipes and conduit disposed behind drywall wallboard within a room in a building. Methods of using the same are further provided.

To this end, in an embodiment of the present invention, an apparatus for indicating the location of in-wall pipe and conduit within a wall, the wall having at least one stud, is provided. The apparatus comprises: a block and a first flange, wherein the block has a thickness measuring approximately the thickness of wallboard forming the wall, and further wherein the first flange is disposed on a first side of the block for fixing the first flange to the at least one stud of the wall.

In an embodiment, the first flange is fixed to the at least one stud via a connector, the connector selected from the group consisting of adhesive, a nail, a screw, a staple, a rivet, and any combination thereof.

In an embodiment, the first flange comprises an aperture for receiving a connector therethrough for fixing the first flange to the at least one stud of the wall.

In an embodiment, the apparatus further comprises a second flange, the second flange disposed on a second side of the block for fixing the second flange to a second stud of the wall.

In an embodiment, the second flange is fixed to the second stud of the wall via a connector, the connector selected from the group consisting of adhesive, a nail, a screw, a staple, a rivet, and any combination thereof.

In an embodiment, the second flange comprises an aperture for receiving a connector therethrough for fixing the second flange to the second stud of the wall.

In an embodiment, the distance between the first flange and the second flange is approximately the same distance between studs within the wall.

In an embodiment, the apparatus further comprises a second flange disposed on a bottom side of the block, wherein the second flange is bendable to approximately 90 degrees compared to the first flange, wherein the second flange lays on a surface disposed approximately 90 degrees to the wall when the apparatus is fixed to the at least one stud.

In an embodiment, the apparatus is made from a material selected from the group consisting of wood, drywall wallboard, metal, plastic, glass, fiberglass, rubber, and any combination thereof.

In an embodiment, the apparatus further comprises: an indicator on a surface of the block, the indicator communicating the presence of the apparatus when fixed to the at least one stud.

In an embodiment, the indicator is selected from the group consisting of a removable fin, a raised surface, a textured surface, a colored surface, a lettered surface, a film, an opaque surface, a transparent surface, and any combination thereof.

In an alternate embodiment of the present invention, a system is provided. The system comprises: a wall having a first stud and a second stud and an in-wall conduit running between the first stud and the second stud; and an apparatus comprising a block and a first flange, wherein the block has a thickness measuring approximately the thickness of wallboard forming the wall, and the first flange disposed on a first side of the block, the first flange fixed to the first stud of the wall.

In an alternate embodiment, the first flange is fixed to the wall via a connector, wherein the connector is selected from the group consisting of adhesive, a nail, a screw, a staple, a rivet, and any combination thereof.

In an alternate embodiment, the block comprises a second flange disposed on a second side of the block, the second flange fixed to the second stud of the wall.

In an alternate embodiment, the second flange is fixed to the second stud of the wall via a connector, the connector selected from the group consisting of adhesive, a nail, a screw, a staple, a rivet, and any combination thereof.

In an alternate embodiment, the second flange comprises an aperture for receiving a connector therethrough for fixing the second flange to the second stud of the wall.

In an alternate embodiment, the distance between the first flange and the second flange is approximately the same distance between the first and second studs.

In an alternate embodiment, the wall comprises wallboard, and further wherein the wall board has a cut-out section in the shape of the block, the block fitting within the cut-out section.

In a still further alternate embodiment of the present invention, a method of using indicating the location of in-wall pipe and conduit within a wall is provided. The method comprises the steps of: providing a wall having a first stud and a second stud and an in-wall conduit running between the first stud and the second stud; providing an apparatus comprising a block and a first flange, wherein the block has a thickness measuring approximately the thickness of wallboard forming the wall, and further wherein the first flange is disposed on a first side of the block; and fixing the first flange to the first stud of the wall.

In a still further alternate embodiment, the method further comprises the steps of: providing an second flange disposed on a second side of the block; and fixing the second flange to the second stud of the wall.

Therefore, it is an advantage of the present invention to provide apparatuses, systems and methods of using the same that provide an indication relating to the location of pipes, conduits and/or other materials that may be contained behind walls.

Specifically, it is an advantage of the present invention to provide apparatuses, systems and methods of using the same that provide information concerning the specific location of pipes, conduits and/or other materials behind walls during the construction of a building.

Moreover, it is an advantage of the present invention to provide apparatuses, systems and methods of using the same that provide an immovable indicator for providing the location of pipes, conduits and/or other materials behind walls.

It is a further advantage of the present invention to provide apparatuses, systems and methods of using the same that allow an individual to obtain precise location information concerning the location of the pipes, conduits and/or other materials contained behind the walls within a room.

Further, it is an advantage of the present invention to provide apparatuses, systems and methods of using the same that requires an individual to provide an acknowledgment of receiving the information concerning the location of the pipes, conduits and/or other material located behind a wall during construction thereof.

Still further, it is an advantage of the present invention to provide apparatuses, systems and methods of using the same that allow viewing of the pipes, conduits and/or other materials behind a wall, even after construction of the wall.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present embodiments, by way of example only, not by way of limitations. In the figures, like reference numerals refer to the same or similar elements.

FIG. 1 illustrates a perspective view of an in-wall pipe and conduit location indicator apparatus in an embodiment of the present invention.

FIG. 2 illustrates a side view of the in-wall pipe and conduit location indicator apparatus in an embodiment of the present invention.

FIG. 3 illustrates a perspective view of an in-wall pipe and conduit location indicator apparatus with raised markings thereon in an embodiment of the present invention.

FIG. 4 illustrates a side view of the in-wall pipe and conduit location indicator apparatus with raised markings thereon in an embodiment of the present invention.

FIG. 5 illustrates a perspective view of an in-wall pipe and conduit location indicator apparatus with a snap-off flange in an embodiment of the present invention.

FIG. 6 illustrates a side view of the in-wall pipe and conduit location indicator apparatus with the snap-off flange in an embodiment of the present invention.

FIG. 7 illustrates a perspective view of an in-wall pipe and conduit location indicator apparatus disposed on a wall having pipes and conduit in an embodiment of the present invention.

FIG. 8 illustrates a perspective view of a wall and in-wall pipe and conduit location indicator apparatus disposed in the wall in an embodiment of the present invention.

FIG. 9 illustrates a perspective view of a transparent in-wall pipe and conduit location indicator apparatus disposed on a wall having pipes and conduit in an embodiment of the present invention.

FIG. 10 illustrates a perspective view of a transparent in-wall pipe and conduit location indicator apparatus with a peelable front surface on a wall having pipes and conduit in an embodiment of the present invention.

FIG. 11 illustrates a perspective view of an in-wall pipe and conduit location indicator apparatus with a peelable front surface on a wall having pipes and conduit in an embodiment of the present invention.

FIG. 12 illustrates a perspective view of an in-wall pipe and conduit location indicator apparatus with a floor location indicator in an embodiment of the present invention.

### DETAILED DESCRIPTION OF THE PRESENTLY PREFERRED EMBODIMENTS

The present invention relates to an apparatus for indicating the location of pipe and conduit that may be within or behind walls. Specifically, the present invention relates to an in-wall pipe and conduit location indicator apparatus for indicating the presence and location of pipes and conduit disposed behind drywall wallboard within a room in a building. Methods of using the same are further provided.

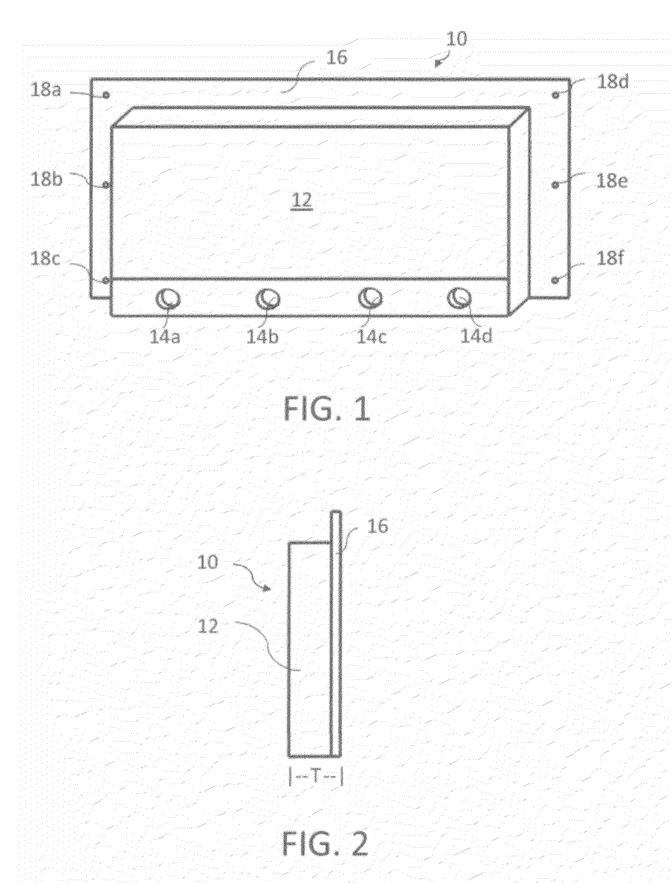

Now referring to the drawings, FIG. 1 illustrates an in-wall pipe and conduit location indicator apparatus 10. The apparatus 10 comprises a block 12. The block may preferably be made from molded thermoplastic, although the block may be any material apparatus to one of ordinary skill in the art, such as wood, drywall wallboard, metal or any other material. The block further comprises a plurality of holes 14a, 14b, 14c and 14d therein, providing passage for a nail or a screw (not shown in FIG. 1), although the apparatus 10 may have any number and placement of holes. Placement of a nail or screw within at least one of the holes 14a-14d allows the apparatus 10 to be fixed to a stud or a baseboard at the bottom of a wall prior to the fixing of drywall wallboard on the wall.

Disposed on the sides of the block 10 may be a flange 16. The flange 16 may be made of relatively thin thermoplastic, metal, wood, or any other material that allows the apparatus 10 to be fixed to studs that may make up the interior of a wall during construction of the wall. Preferably, the flange 16 extends from three of the four sides of the block 12. Specifically, the flange 16 may extend a distance away from the block 12. Preferably, the flange 16 may extend up to about an inch from the block 12. Moreover, the flange 16 may have a plurality of holes 18a, 18b, 18c, 18d, 18e and 18f disposed in various locations around the flange 16 to allow passage of a nail or screw for fixing the flange 16 and, thus, the apparatus 10 to studs that may be contained within a wall, although any number of holes may be disposed within the flange for fixing the flange to studs or other wall features for fixing the same thereto.

Generally, the apparatus 10 is placed against studs and a baseboard (as described in more detail below) prior to the placement of drywall wallboard on the wall. Alternatively, the apparatus 10 may be fixed to a header board and studs near a ceiling within a room. The apparatus 10 is affixed to the studs and/or baseboard/header board by placing nails and/or screws through at least one of the holes 14a-14d and/or 18a-18f, respectively. Thus, when drywall wallboard is placed on the wall, the drywall will be required to be cut at the location of the apparatus 10 to fit the apparatus 10 in the wall formed thereby. Because the apparatus 10 will still be visible, even after the placement of drywall wallboard on the wall, those individuals placing nails and/or screws through the wall, such as finishers placing trim on the walls, will notice the presence of the apparatus 10, indicating that they ought to be careful and not use nails and/or screws in that location of the wall so as not to puncture or otherwise damage pipes, conduits and/or other material contained within the wall at this location.

The apparatus 10, therefore, may be brightly colored to draw attention to it, or may have instructions printed thereon. Specifically, the surface of the block 12 may be bright colored, such as a fluorescent color to ensure attention is drawn to it, minimizing the risk that an individual will place a nail or screw through the wall at that location. Alternatively, the surface of the block 12 may have a markable surface, such as a textured surface, for writing thereon. Therefore, one who utilizes the apparatus 10 may write instructions on the surface of the block 12, or provide a map for pipes and/or conduits contained behind the wall. As described below, the apparatus 10 may be placed along a baseboard near the floor of a room, or along the header board near the ceiling of the room. The apparatus 10 may preferably have a height that is covered by trim that may extend over the apparatus and the wall at that location.

FIG. 2 illustrates a side view of the apparatus 10, illustrating the relative positions of the block 12 and the flange 16. Generally, the flange 16 has a thickness that, when combined with the thickness of the block 12 forms a thickness T, is roughly the same thickness as drywall wallboard.

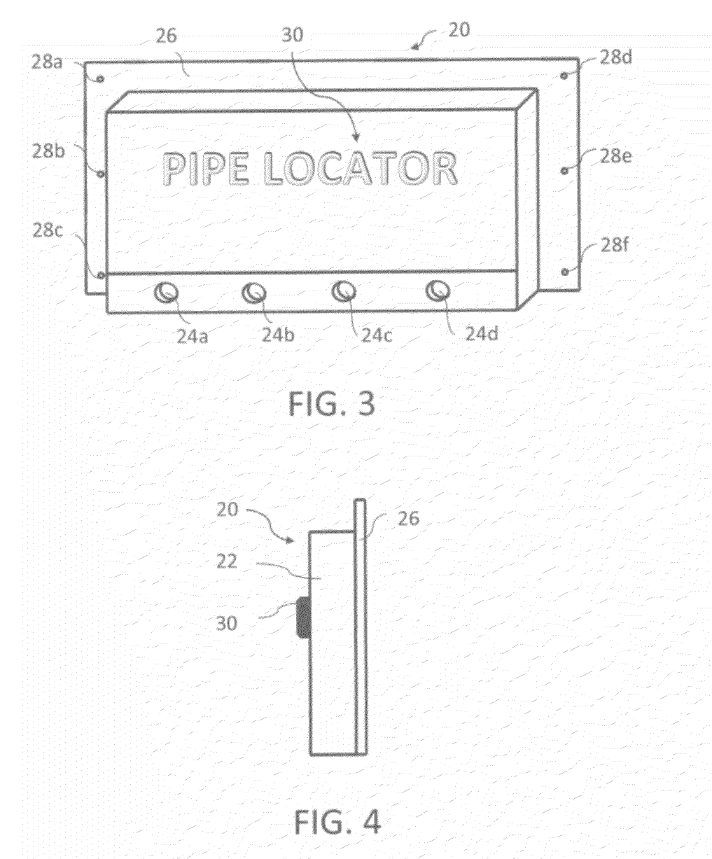

Now referring to FIG. 3, in an alternate embodiment of the present invention, an apparatus 20 is provided. The apparatus 20 may have a block 22, holes 24a-24d, and a flange 26 having holes 28a-28f. Generally, the apparatus 20 may be generally similar to the apparatus 10, as described above with reference to FIGS. 1 and 2. Disposed on the block 22 may be markings 30 comprising raised lettering, for example. As illustrated in FIG. 4, the raised lettering may extend a distance from the surface of the block 22. Generally, the markings 30 extend from the block in an exaggerated fashion in FIG. 4, for purposes of illustration. The markings may generally extend any distance from the block 22 so that they are readily seen by an individual, even if the surface of the block 22 is painted thereover.

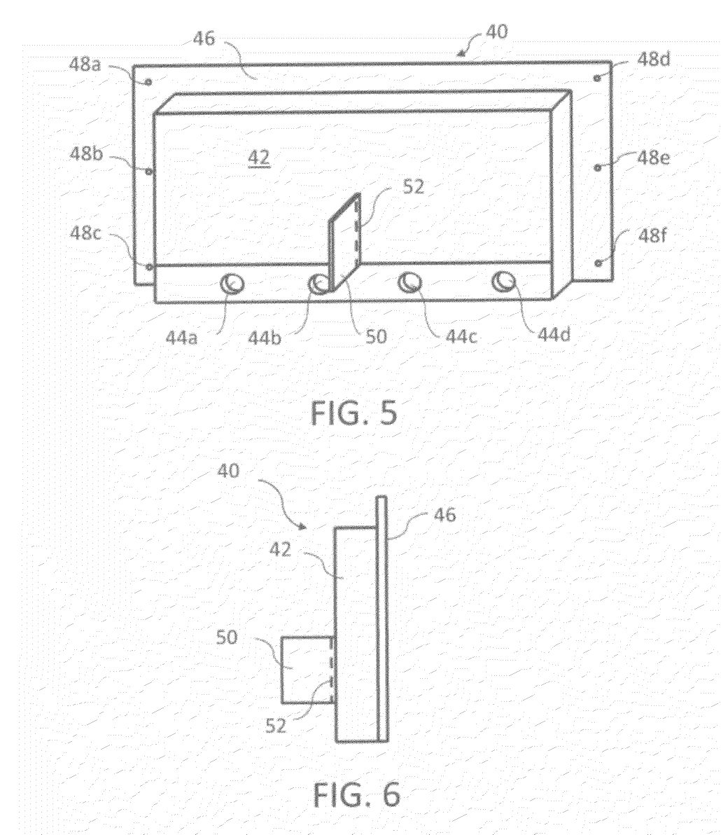

FIGS. 5 and 6 illustrate an alternate embodiment of an apparatus 40, generally similar to the apparatuses 10 and 20, described above with reference to FIGS. 1-4. Specifically, the apparatus 40 may contain a block 42, and a flange 46, and holes 44a-44d and 48a-48f, respectively. The block may further contain a fin 50 disposed on the surface of the block 42 and extending away from the block 42. The fin 50 may be made from relatively thin plastic, wood, metal or any other material apparent to one of ordinary skill in the art. Preferably, the fin 50 is a relatively thin piece of plastic. The fin 50 may have a weakened line 52 disposed thereon, near the base of the fin 50 where the fin 50 extends from the block 42. Thus, an individual may be able to snap the fin 52 off of the apparatus 40. This provides a reminder to an individual that the apparatus 40 is placed on a wall in a location where pipes, conduits and/or other material may be disposed therebehind, and the individual is cautioned not to use nails and/or screws in that specific location. For example, an individual tasked with placing trim on the wall may nail and/or screw the trim to the wall until the individual reaches the location where the apparatus 40 is disposed in the wall. At that location, the individual will be required to snap the fin 50 off the apparatus 40, thereby providing the individual with a reminder not to use nails and/or screws in that location. Thus, snapping off the fin 50 functions as an acknowledgment by the individual that the individual has received the message that pipes, conduits and/or other material lay behind the wall at that location.

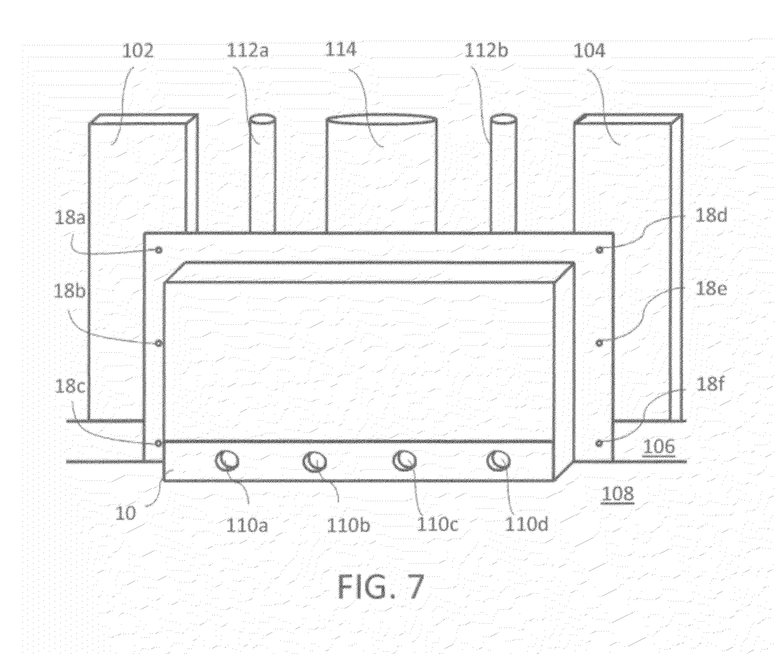

FIG. 7 illustrates an embodiment of the apparatus 10 disposed on studs 102, 104 and/or a baseboard 106 that may run horizontally near the a floor 108 of a room. Alternatively, the apparatus 10 may be fixed near the ceiling on a header board and/or studs (not shown). In an alternate embodiment, the apparatus may be provided in any location on the wall, fixed on and bridging studs.

A plurality of nails 110a, 110b, 110c, 110d may be disposed through the holes 14a-14d, fixing the apparatus 10 to the baseboard 106. One or more nails and/or screws may also be disposed through the holes 18a-18f (not shown) to fix or help fix the apparatus 10 to the studs 102, 104. As illustrated, pipes 112a, 112b and conduit 114 may be disposed between the studs 102, 104, and the apparatus 10 may be placed thereover to indicate that the pipes 112a, 112b, conduit 114 or any other material, is disposed there.

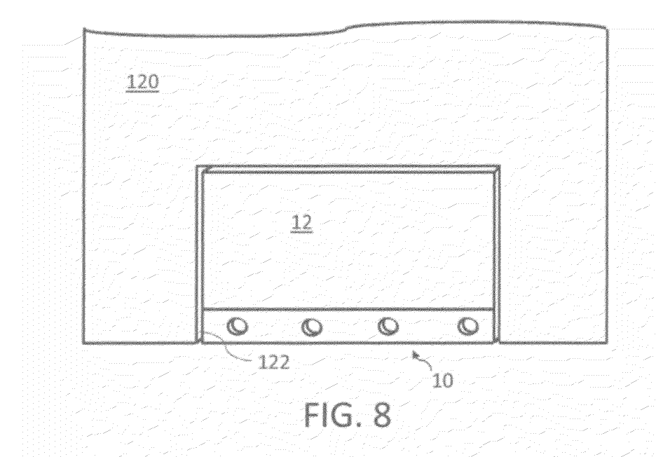

FIG. 8 illustrates an apparatus 10, having been placed on a wall thereby indicating that pipes, conduits and/or other material is located behind the wall in that location. Moreover, drywall wallboard 120 may then be placed on the wall in a normal fashion, except that the drywall wallboard 120 may have a cut-out section 122 generally shaped and sized to fit the block 12 of the apparatus 10. Because the thickness of the apparatus 10 is generally the same thickness of the drywall wallboard 120, the apparatus 10 does not substantially protrude any distance relative to the drywall wallboard. However, the apparatus 10 may generally be noticeable by an individual, and an individual may generally be prevented from placing nails and/or screws through the wall at this location. If the individual is placing trim on the wall, the individual may be reminded to use adhesive in this location to prevent accidental damage to or puncturing of pipes, conduits and/or material contained behind the wall at that location.

In an alternate embodiment of the present invention, an apparatus 60 may be provided and disposed on studs 102, 104. The apparatus 60 may be generally similar to the apparatuses 10, 20 and 40, described above. However, the apparatus 60 may have a block 62 that is transparent or translucent, such that an individual may view the pipes 112a, 112b, conduit 114, or any other material contained therebehind. Thus, once the drywall wallboard is placed therearound (not shown), an individual may be able to view inside the wall at this location to see the pipes 112a, 112b, conduit 114 and/or other material. Thus, an individual may be able to precisely locate and determine what pipes, conduit and/or other material may be disposed behind a wall at a particular location, even after drywall wall board is placed thereon.

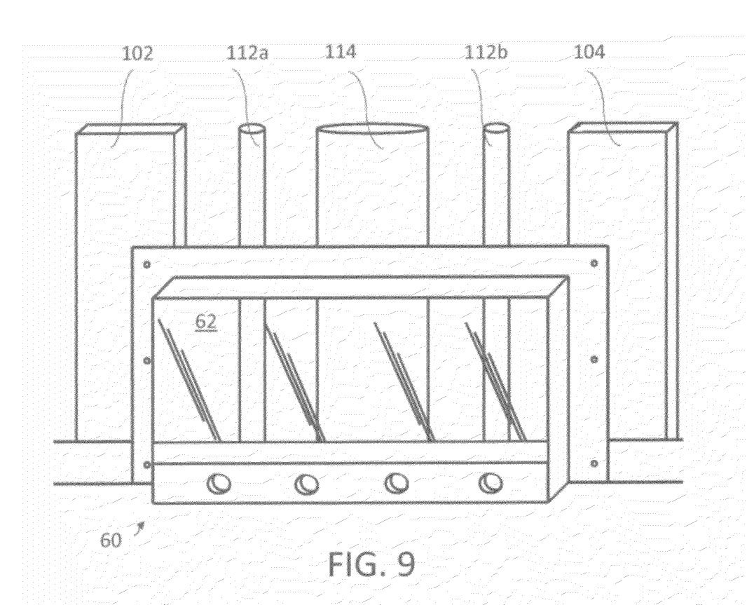

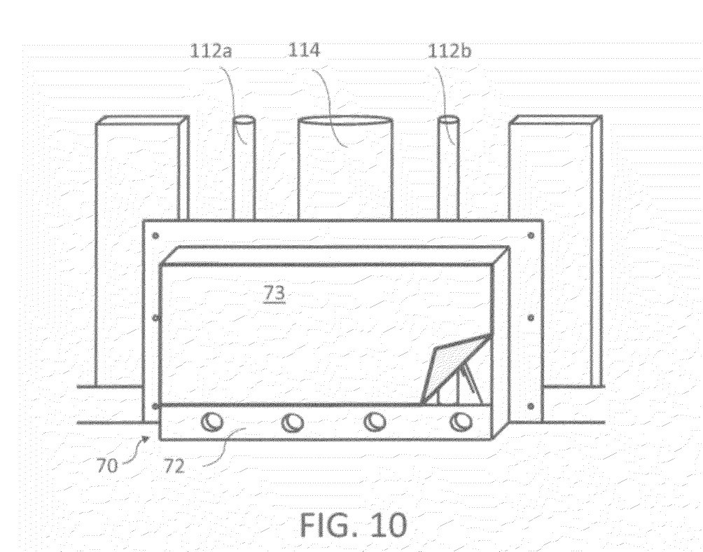

FIG. 10 illustrates an alternate embodiment of the present invention, or an apparatus 70 having a transparent block 72, generally as described above with respect to FIG. 9 so that an individual may see therethrough. Disposed on a surface of the transparent block 72 may be a film 73 that may be peelable from the surface of the block 72. The film 73 may also be transparent, or may be opaque. However, the film 73 may allow an individual to expose the transparent block 72, thereby allowing the individual to see therethrough at the pipes 112a, 112b, conduit 114 and/or other material disposed therebehind. Thus, if the film 73 is painted (as many walls are before trim is placed thereon), an individual may simply peel the film 73, removing the paint that may have been painted thereon, exposing the transparent block 72.

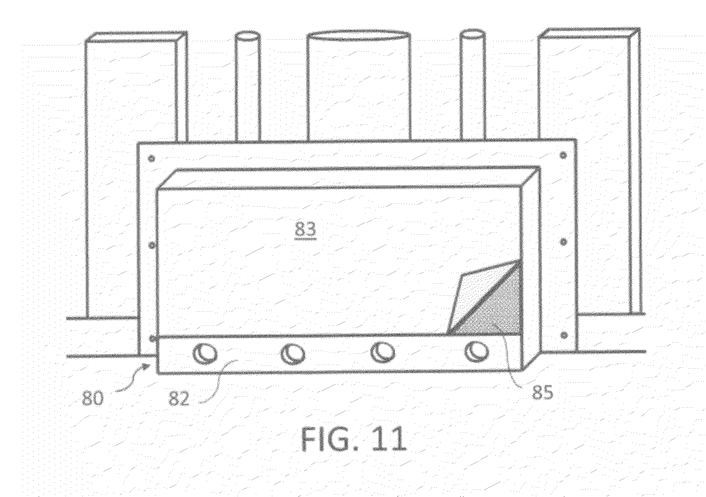

Alternatively, as illustrated in FIG. 11, the apparatus 80 may have an opaque block 82 that may have a surface 85 that may be brightly colored, or may contain markings or instructions thereof. Thus, peeling a film 83 from the block 82 may expose the surface 85 and, therefore, the bright color, markings or instructions disposed thereunder. This may be useful if the apparatus 80 is painted thereover. Peeling the film 83 from the surface 85 of the block 82 may make the apparatus 80 highly visible, even after being painted thereon.

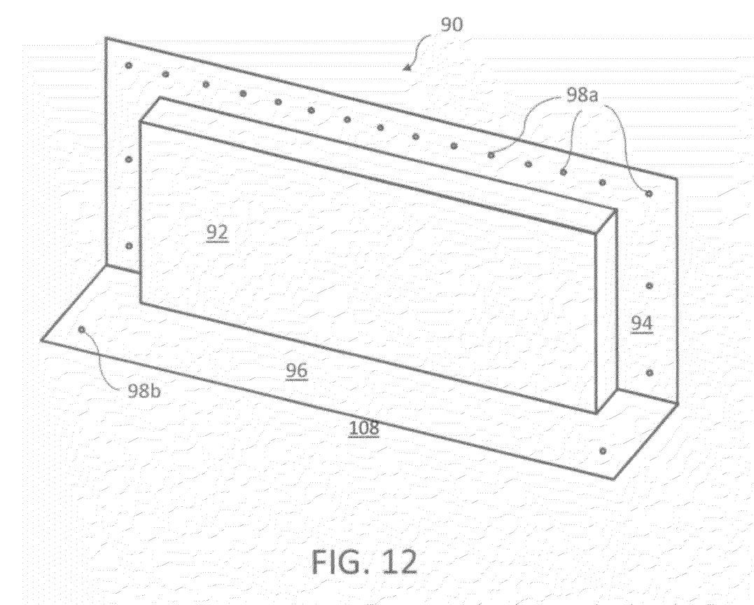

FIG. 12 illustrates an alternate embodiment of the present invention of an apparatus 90. The apparatus 90 may have a block 92, which may indicate the mapping of pipes and/or conduit located behind apparatus 90. The block 92 may contain writing on the surface for indicating caution and/or instructions, as described above. A first flange 94 and a second flange 96 may be disposed about the block 92 and may be used for securing apparatus 90 in place. The first flange 94 may contain a plurality of holes 98a for securing the first flange 94 to a baseboard or studs via nails or screws. The second flange 96 may contain a plurality of holes 98b for securing the second flange 96 to a floor 108 or any other adjacent surface such as a ceiling or raised platform. Specifically, the second flange 96 may be bent and disposed, as shown in FIG. 12, approximately 90 degrees relative to the first flange 94, and disposed on or adjacent to a surface that is approximately 90 degrees from the wall, such as a floor or ceiling.

Any number of holes 98a, 98b may be disposed within the first flange 94 and the second flange 96 for fixing the first flange 94 to studs or fixing the second flange 96 to the surface that is disposed 90 degrees to the wall, or any other adjacent surface. The second flange 96 may indicate the location of apparatus 90 on the floor 108 or other adjacent surface if block 92 and flange 94 are covered during the construction process.

It should be noted that various changes and modifications to the presently preferred embodiments described herein will be apparent to those skilled in the art. Such changes and modifications may be made without departing from the spirit and scope of the present invention and without diminishing its attendant advantages. For example, embodiments of the present invention may contain one or more features as described herein, in combination.

I claim:

1. An apparatus for indicating the location of in-wall pipe and conduit within a wall, the wall having at least one stud, the apparatus comprising:
a block and a first flange, wherein the block has a thickness measuring approximately the thickness of wallboard forming the wall, and further wherein the first flange is disposed on a first side of the block for fixing the first flange to the at least one stud of the wall.

2. The apparatus of claim 1 wherein the first flange is fixed to the at least one stud via a connector, the connector selected from the group consisting of adhesive, a nail, a screw, a staple, a rivet, and any combination thereof.

3. The apparatus of claim 1 wherein the first flange comprises an aperture for receiving a connector therethrough for fixing the first flange to the at least one stud of the wall.

4. The apparatus of claim 1 further comprising a second flange, the second flange disposed on a second side of the block for fixing the second flange to a second stud of the wall.

5. The apparatus of claim 4 wherein the second flange is fixed to the second stud of the wall via a connector, the connector selected from the group consisting of adhesive, a nail, a screw, a staple, a rivet, and any combination thereof.

6. The apparatus of claim 4 wherein the second flange comprises an aperture for receiving a connector therethrough for fixing the second flange to the second stud of the wall.

7. The apparatus of claim 4 wherein the distance between the first flange and the second flange is approximately the same distance between studs within the wall.

8. The apparatus of claim 1 further comprising a second flange disposed on a bottom side of the block, wherein the second flange is bendable to approximately 90 degrees compared to the first flange, wherein the second flange lays on a surface disposed approximately 90 degrees to the wall when the apparatus is fixed to the at least one stud.

9. The apparatus of claim 1 wherein the apparatus is made from a material selected from the group consisting of wood, drywall wallboard, metal, plastic, glass, fiberglass, rubber, and any combination thereof.

10. The apparatus of claim 1 further comprising:
an indicator on a surface of the block, the indicator communicating the presence of the apparatus when fixed to the at least one stud.

11. The apparatus of claim 1 wherein the indicator is selected from the group consisting of a removable fin, a raised surface, a textured surface, a colored surface, a lettered surface, a film, an opaque surface, a transparent surface, and any combination thereof.

12. A system comprising:
a wall having a first stud and a second stud and an in-wall conduit running between the first stud and the second stud; and
an apparatus comprising a block and a first flange, wherein the block has a thickness measuring approximately the thickness of wallboard forming the wall, and the first flange disposed on a first side of the block, the first flange fixed to the first stud of the wall.

13. The system of claim 12 wherein the first flange is fixed to the wall via a connector, wherein the connector is selected from the group consisting of adhesive, a nail, a screw, a staple, a rivet, and any combination thereof.

14. The system of claim 12 wherein block comprises a second flange disposed on a second side of the block, the second flange fixed to the second stud of the wall.

15. The system of claim 14 wherein the second flange is fixed to the second stud of the wall via a connector, the connector selected from the group consisting of adhesive, a nail, a screw, a staple, a rivet, and any combination thereof.

16. The system of claim 14 wherein the second flange comprises an aperture for receiving a connector therethrough for fixing the second flange to the second stud of the wall.

17. The system of claim 14 wherein the distance between the first flange and the second flange is approximately the same distance between the first and second studs.

18. The system of claim 12 wherein the wall comprises wallboard, and further wherein the wall board has a cut-out section in the shape of the block, the block fitting within the cut-out section.

19. A method of using indicating the location of in-wall pipe and conduit within a wall, the method comprising the steps of:
providing a wall having a first stud and a second stud and an in-wall conduit running between the first stud and the second stud;
providing an apparatus comprising a block and a first flange, wherein the block has a thickness measuring approximately the thickness of wallboard forming the wall, and further wherein the first flange is disposed on a first side of the block, fixing the first flange to the first stud of the wall.

20. The method of claim 19 further comprising the steps of:
providing an second flange disposed on a second side of the block; and
fixing the second flange to the second stud of the wall.
